(19) United States
(12) Patent Application Publication
(10) Pub. No.: US 2023/0290265 A1
(43) Pub. Date: Sep. 14, 2023

(54) FIRE SPRINKLER SYSTEM INSTALLATION TRAINING KIT AND METHOD

(71) Applicant: Roy Joseph Savoie, Shediac (CA)

(72) Inventor: Roy Joseph Savoie, Shediac (CA)

(21) Appl. No.: 17/691,426

(22) Filed: Mar. 10, 2022

(51) Int. Cl. G09B 19/00; A62C 99/00; G09B 25/04

(52) U.S. Cl. CPC G09B 19/00; A62C 99/0081; G09B 25/04

(57) ABSTRACT

A kit for teaching fire sprinkler system installation includes a model structure assembly, a model sprinkler system and at least one plan. The kit provides necessary elements for building a model structure and for installing a model fire sprinkler system within the model structure offering a fun and educational activity to children, teenagers, young adults, and/or the entire family while teaching how to install a real fire sprinkler system within a building.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fire protection of existing art and more specifically relates to a fire sprinkler system replica kit for training a user on how to install fire sprinkler systems into a structure.

### RELATED ART

Fire protection systems are used around the world to prevent, or at least mitigate, damage to buildings and prevent, or at least mitigate, harm to building occupants. A fire sprinkler system is a fire protection method consisting basically of a water supply, a piping system connected to the water supply and a plurality of sprinkler heads located in various zones in the building. The piping system carries water from the water supply to the sprinkler heads and the sprinkler heads are configured to discharge water when a fire is detected, thereby working to put the fire out. Fire sprinkler systems have been used for hundreds of years to protect commercial buildings, parking garages, residential homes, and the like. Due to the importance of these sprinkler systems, it is vital that professionals are able to correctly install them. It also preferable that other individuals have an understanding and interest in sprinkler systems. As such, a suitable solution is desired.

### SUMMARY OF THE INVENTION

In view of the foregoing disadvantages inherent in the known fire protection art, the present disclosure provides a novel fire sprinkler system installation training kit and method. The general purpose of the present disclosure, which will be described subsequently in greater detail, is to provide a kit including a replica fire sprinkler system and a replica building structure for allowing a user to learn installation of fire sprinkler systems; and a method of learning fire sprinkler system installation utilizing the fire sprinkler system installation training kit.

A kit for teaching fire sprinkler system installation is disclosed herein. The kit may include a model structure assembly, a model fire sprinkler system and at least one plan. The model structure assembly may include at least one floor, at least one ceiling and a plurality of walls all configured to be assembled together to form a model structure having at least one story and at least one room. The model fire sprinkler system may be configured for installation into the model structure. The model fire sprinkler system may include a main control assembly having an inlet assembly and a plurality of control valves, a network of pipes configured for connection to the inlet assembly, a plurality of structure connector means configured to connect the network of pipes to the model structure, and a plurality of sprinkler heads attached to the network of pipes and configured for installation about the at least one ceiling of the at least one room. The at least one plan may visually outline information for assembly of the model structure and for installation of the model fire sprinkler system within the model structure.

According to another embodiment, a method of learning fire sprinkler system installation is also disclosed herein. The method includes providing the kit as above; assembling the model structure according to the at least one plan; installing the main control assembly within the model structure; connecting the network of pipes with the main control assembly; positioning each structure connector means from the plurality of structure connector means according to the at least one plan; connecting the network of pipes to the model structure via the plurality of structure connector means; and aligning each sprinkler head according to the at least one plan.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fire sprinkler system installation training kit and method, constructed and operative according to the teachings of the present disclosure.

FIG. 1 is a perspective view of a kit being assembled according to an embodiment of the disclosure.

FIG. 2 is a front view of a main control assembly of a model sprinkler system, according to an embodiment of the present disclosure.

FIG. 3 is a schematic diagram of a plan visually outlining information for assembly of a model structure and for installation of the model fire sprinkler system within a model structure, according to an embodiment of the present disclosure.

FIG. 4 is a schematic diagram of another plan visually outlining information for assembly of the model structure and for installation of the model fire sprinkler system within the model structure, according to an embodiment of the present disclosure.

FIG. 5 is a front view of the model structure and the model fire sprinkler system installed therewithin according to the plan in FIG. 3, according to an embodiment of the disclosure.

FIG. 6 is a side view of the model structure and the model fire sprinkler system installed therewithin according to the plan in FIG. 3, according to an embodiment of the disclosure.

FIG. 7 is a front view of the model structure and the model fire sprinkler system installed therewithin according to the plan in FIG. 4, according to an embodiment of the disclosure.

FIG. 8 is a side view of the model structure and the model fire sprinkler system installed therewithin according to the plan in FIG. 4, according to an embodiment of the disclosure.

FIG. 9 is a flow diagram illustrating a method of learning fire sprinkler system installation, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to fire protection and more particularly to a fire sprinkler system installation training kit and method. Generally, the fire sprinkler system installation training kit may be a toy that offers fun to children, teenagers, young adults, and/or the entire family while teaching how to install a fire sprinkler system within a building. The kit may provide necessary elements for building a structure and for installing a fire sprinkler within the structure. For example, the kit may include butterfly valves, check valves, backflow preventor, fire department connector, flow switch, test and drain valve, groove couplings, groove fittings, elbows, caps, tee-fittings, threaded fittings, pipes, hangers, threaded rods, beam clamps, beams, and the like. In some embodiments, the kit may provide a compressor and a dry pipe valve for replicating dry fire sprinkler systems.

In using the kit, the user (such as a child) may choose a floor plan and begin by building the structure according to the floor plan. The user may build a sprinkler room whereby a main portion of the fire sprinkler system may be installed. The user may then begin placing hangers in different areas of the structure (according to the floor plan) and connecting pipes. If done correctly, sprinkler heads attached to the pipes may line up in each area in the correct place. A “dot” on the floor plan may indicate location for sprinkler heads in each area.

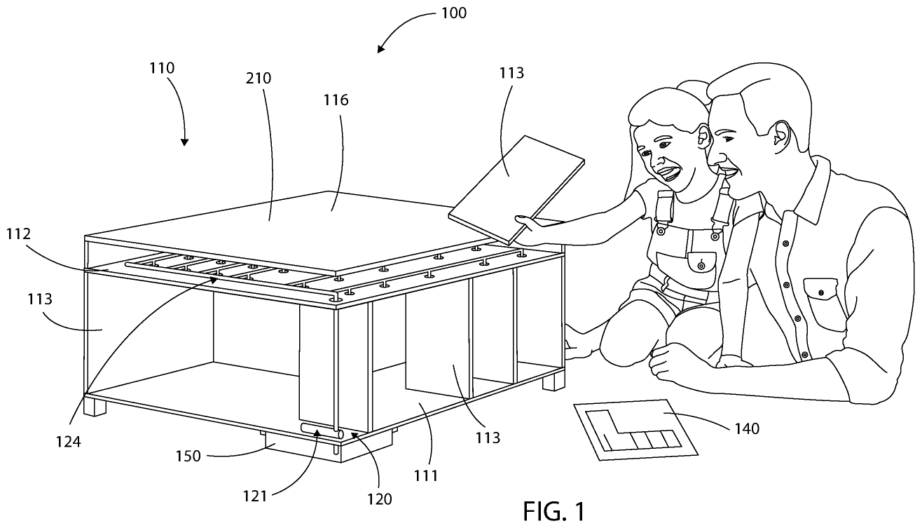

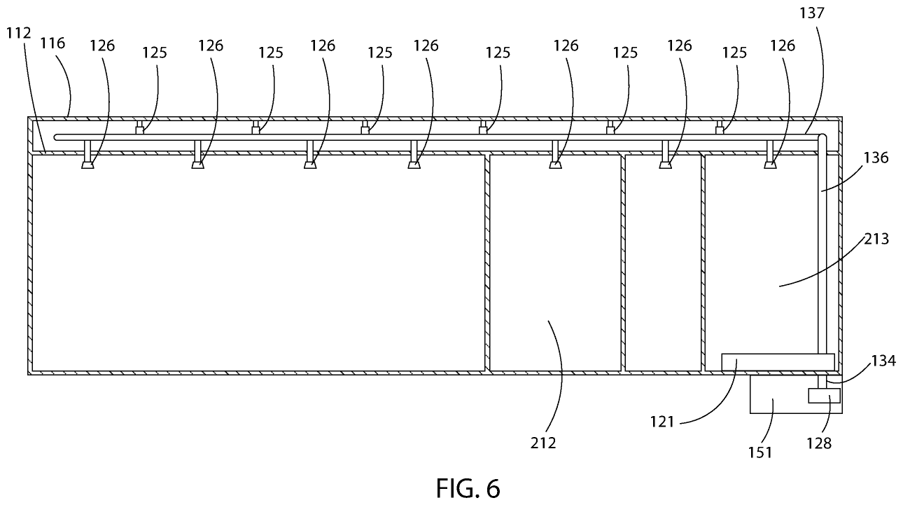

Referring now more specifically to the drawings by numerals of reference, there is shown in FIGS. 1-8, various views of a kit 100. As discussed above, the kit 100 may be used for teaching fire sprinkler system installation. Particularly, as demonstrated in FIG. 1, the kit 100 may be used for teaching children, teenagers, young adults, etc. how to install fire sprinkler systems within a building. The kit 100 may be used to create a system that is a model/replica of a standard fire sprinkler system. For example, in some embodiments, the system may be a model of a wet fire sprinkler system. In other embodiments, the system may be a model of a dry fire sprinkler system. Preferably, the system may be a working model that allows a user to test their installation. As shown in FIG. 1, the kit 100 may include a model structure assembly 110, a model fire sprinkler system 120 and at least one plan 140. In some embodiments, the kit 100 may allow different elements of the model structure assembly 110 and the model fire sprinkler system 120 to be assembled/installed according to desire, particular installation, plan 140, etc.

The model structure assembly 110 may include at least one floor 111, at least one ceiling 112, and a plurality of walls 113 all configured to be assembled together to form a model structure 210 having at least one story 211 and at least one room 212. In some embodiments, the model structure assembly 110 may include a roof 116. Further, the model structure assembly 110 may include a plurality of beams (not illustrated). Preferably, the user may be able to assemble the model structure 210 to include as many stories 211 and/or rooms 212 as desired; and as such, the at least one floor 111 and the at least one ceiling 112 may include a plurality of floors 111 and a plurality of ceilings 112 (to define a plurality of stories 211). The plurality of walls 113 may preferably be assembled to form a plurality of rooms 212. In some embodiments, the plurality of rooms 212 may include a sprinkler room 213.

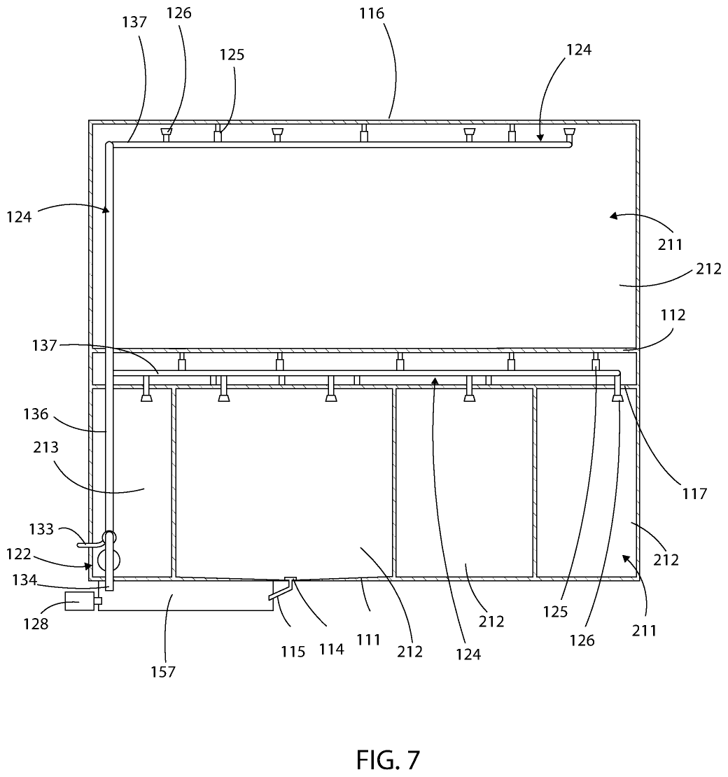

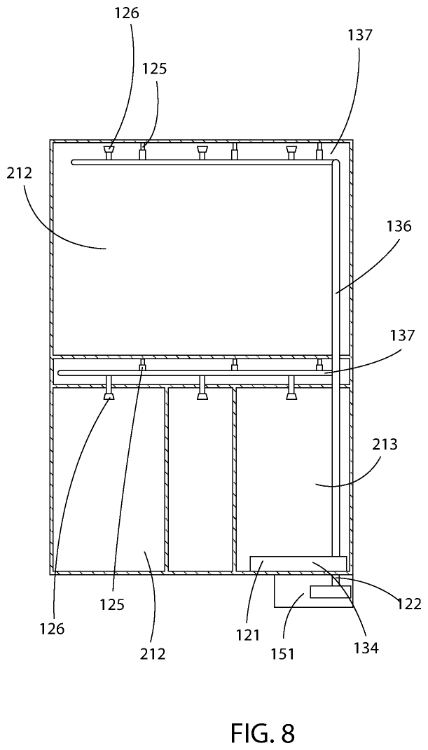

In some embodiments (as shown in FIGS. 7-8), the model structure 210 may include an open concept ceiling 112. In other embodiments, particularly multi-story embodiments, a secondary ceiling 117 (such as a drywall ceiling, drop ceiling) or the like may be provided for installation under the at least one ceiling 112 in order to cover the model fire sprinkler system 120 installed therewithin. In one-story embodiments, the at least one ceiling 112 may include drywall, drop tiles, etc. and the model fire sprinkler system 120 may be installed between the at least one ceiling 112 and the roof 116.

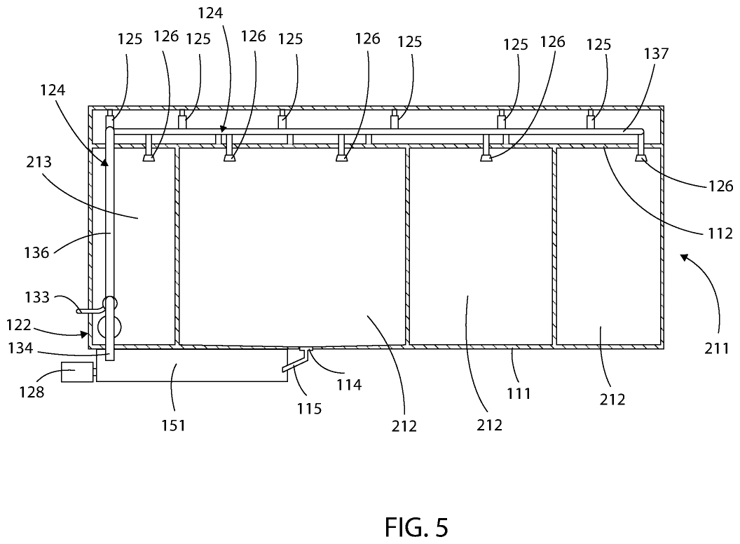

In some embodiments, the at least one floor 111 may include a floor drain 114 and the at least one floor 111 may be angled to direct water into the floor drain 114. As shown in FIG. 5 and FIG. 7, the floor drain 114 may include a drainage pipe 115 configured to expel drained water. In some embodiments, the drainage pipe 115 may include a 90° elbow pipe. In circumstances where the model structure 210 includes a plurality of stories 211 (and thus a plurality of floors 111), the floor drain 114 may be located on a bottom floor of the model structure 210. In this embodiment, other floors may include a drainage system (such as an assembly of vertical pipes) connected to the floor drain 114 to direct the drained water therethrough. As shown in FIG. 5 and FIG. 7, in some embodiments, the drainage pipe 115 may be configured to expel drained water back into a water tank 151, allowing the water to recycle and thereby preventing constant filling of the water tank 151 and also preventing mess.

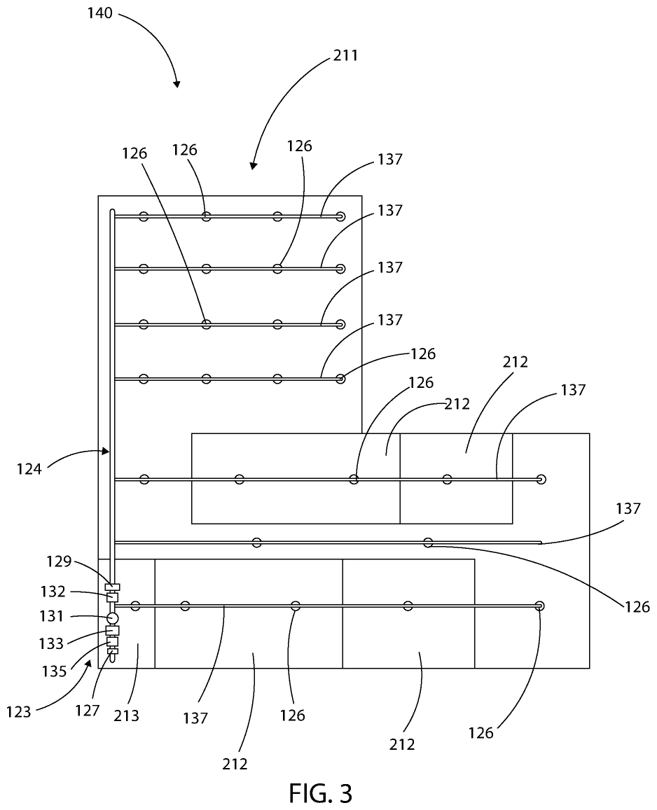

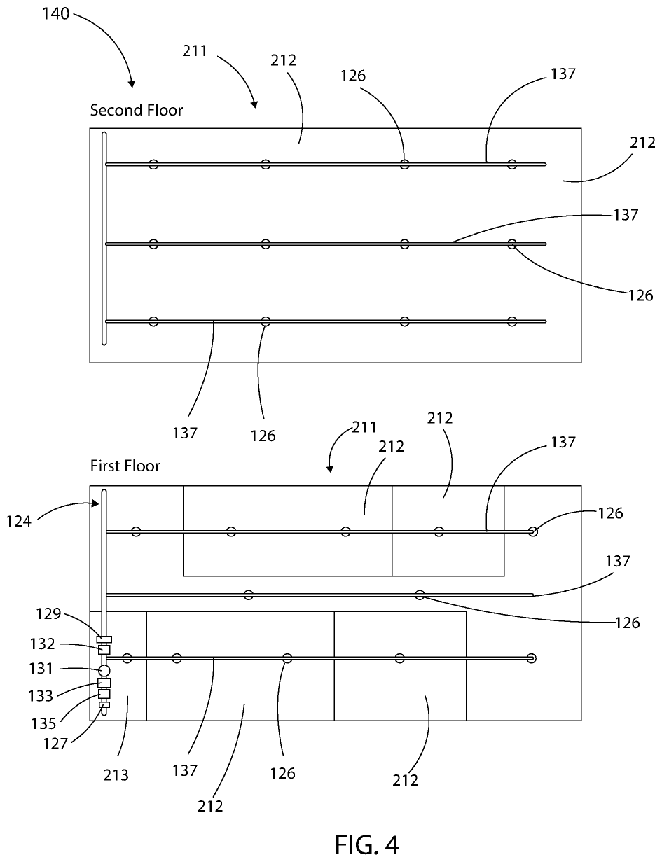

Preferably, as shown in FIGS. 3-4, the at least one plan 140 may outline information for assembly of the model structure 210 such that the user is able to assemble the model structure 210 according to the at least one plan 140. Preferably, the at least one plan 140 may include a plurality of plans and each plan 140 may include different information. The information may particularly include a visual layout (floor plan) of the model structure. As such, each plan 140 may include a different layout (floor plan) to demonstrate how the model structure 210 should be assembled. For example, one plan 140 may outline a one story building as shown in FIG. 3; another plan 140 may outline a two story building as shown in FIG. 4; and so on. FIG. 1 illustrates the model structure 210 having a height of 14 inches, a width of 24 inches and a length of 24 inches, according to the at least one plan 140 shown in FIG. 3.

Further, as shown in FIGS. 3-4, the at least one plan 140 may outline information pertaining to the installation of the model fire sprinkler system. For example, the at least one plan 140 may include a visual layout (such as a technical drawing or schematic) of the model fire sprinkler system 120 when installed within the model structure 210 (for example, where sprinkler heads will go in each room, how many, where sprinkler room 213 will be located, etc.). In another example, the at least one plan 140 may outline a method of installation. It is contemplated that the above described information may be included on one plan 140 (for example, one physical sheet of paper), may be included together as a pamphlet, etc.

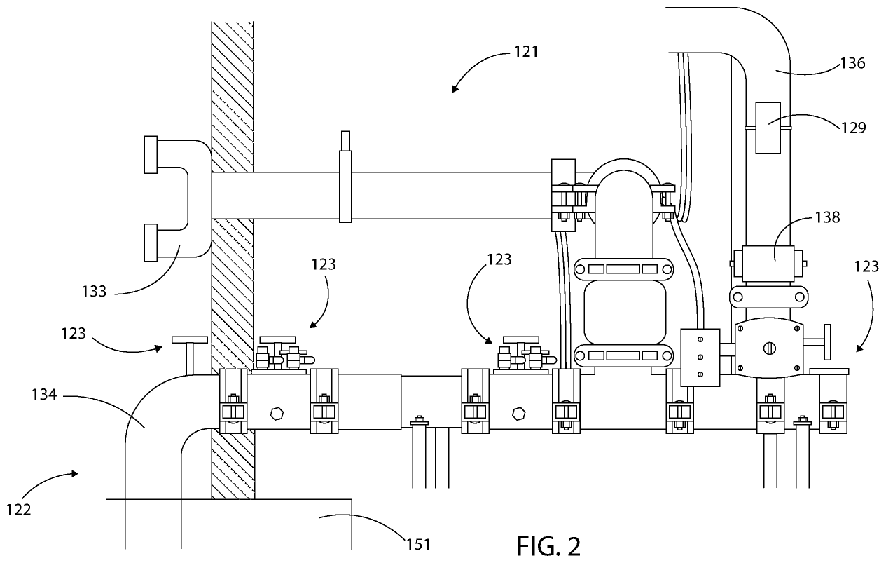

As discussed above, the model fire sprinkler system 120 may be installed into the model structure 210. As shown in FIGS. 2-8, and FIG. 2 specifically, the model fire sprinkler system 120 may include a main control assembly 121 whereby the system can be tested, checked, serviced, etc. all in one place. It should be appreciated that FIG. 2 provides an example embodiment of the main control assembly 121 when assembled and is not meant to limit the main control assembly 121 to a particular configuration or to particular elements.

As above, the model structure 210 may include the sprinkler room 213; as such, the main control assembly 121 may be configured for installation in the sprinkler room 213. As above, the system may preferable be a working model, allowing the user to test their installation. As such, the model fire sprinkler system 120 may include a water supply 150. As shown in FIGS. 5-8 the water supply 150 may include the water tank 151. In some embodiments, the water tank 151 may include a means of filling the water tank 151 with water and a means of draining the water from the water tank 151. For example, the water tank 151 may include a refill/drain aperture that is selectively sealed with a plug. In some embodiments, an electric pump 128 may be provided. It should however be appreciated that the model fire sprinkler system 120 is not limited to having a water supply 150. For example, the model fire sprinkler system 120 may use other fire distinguishing means or may include no water or fire distinguishing means.

As shown, the main control assembly 121 may include an inlet assembly 122, a plurality of control valves 123, at least one backflow preventor means 127, and at least one pressure gauge 131. As shown, the inlet assembly 122 may include an inlet pipe 134 or ‘header’ connected to the water supply 150. In some embodiments, the inlet pipe 134 may be held via a pipe stand, such as a pipe saddle support. In some embodiments, the electric pump 128 may be configured to pump water from the water tank 151 and into the inlet assembly 122. In these embodiments, a battery may be provided for supplying power to the electric pump 128. The plurality of control valves 123 may include a main control valve 135 configured to control intake of water through the system. The plurality of control valves 123 may further include butterfly valves, check valves, or the like. For example, a check valve 138 may be provided on a main pipe 136 of the model fire sprinkler system 120, as shown in FIG. 2, which may prevent backflow and pressure loss. The plurality of valves may include indicating means for indicating open or closed status thereof, especially the main control valve 135.

The at least one backflow preventor means 127 may be configured for connection with the inlet assembly 122. Particularly, the backflow preventor means 127 may be located between the inlet pipe 134 and the water supply 150. The backflow preventor means 127 may be configured to prevent the water from flowing back into the water tank 151. In some examples, the backflow preventor means 127 may utilize double check valves. The at least one pressure gauge 131 may be configured to indicate a pressure of the water. In some embodiments, two pressure gauges may be provided.

Further, in some embodiments, a ‘fire department’ connector 133 (FDP) may be provided with the kit 100. The FDP 133 may be configured for installation on an exterior of the model structure 210 outside of the sprinkler room 213 and connected to the inlet pipe 134, for example, via a pipe tee-fitting. The FDP 133 may enable the user to connect a hose thereto and provide supplemental water to the system. A check valve may also be installed at the pipe tee-fitting to prevent water from flowing back through the hose. In addition, in some embodiments, the main control assembly 121 may include a test and drain valve 132 allowing the user to (selectively) empty the water from the model fire sprinkler system 120.

The model fire sprinkler system 120 may further include a network of pipes 124, a plurality of structure connector means 125, and a plurality of sprinkler heads 126. The network of pipes 124 may be configured for connection to the inlet assembly 122 and configured to carry water therefrom to the plurality of sprinkler heads. Particularly, the network of pipes 124 may include the main pipe 136 or ‘riser’ configured for connection to the inlet pipe 134 and vertically extending therefrom, and a plurality of branch pipes 137 configured to branch from the main pipe 136 in a generally horizontal direction therefrom, parallel to the at least one ceiling 112 of the model structure 210 (when installed). Further, in some embodiments, the network of pipes 124 may include a second plurality of valves (not illustrated) located at various positions therealong and configured to control flow of the water through the network of pipes 124. For example, the second plurality of valves may include butterfly valves.

The plurality of structure connector means 125 may be configured to connect the network of pipes 124 (particularly the plurality of branch pipes 137) to the model structure 210. For example, in some embodiments, the plurality of structure connector means 125 may connect the network of pipes 124 to the at least one ceiling 112 or roof 116 (depending on how many stories 211 the model structure 210 has—as discussed above). In other examples, the plurality of structure connector means 125 may connect the network of pipes 124 to the plurality of beams.

Preferably, the plurality of structure connector means 125 may suspend the network of pipes 124 directly below the at least one ceiling 112 (or roof 116). For example, as shown in FIGS. 5-8, the plurality of structure connector means 125 may suspend the plurality of branch pipes parallel to the at least one ceiling 112. As such, the plurality of structure connector means 125 may include a plurality of hangers, a plurality of beam clamps, and/or a plurality of threaded connectors for attaching the plurality of hangers to the ceiling, beams, etc. In some examples, the kit 100 may include (but is not limited to) 30 hangers, 30 beam clamps and 30 threaded rods.

The plurality of sprinkler heads 126 may be attached to the network of pipes 124 and configured for installation about the at least one ceiling 112 of the at least one room 212. Particularly, the plurality of sprinkler heads 126 may be attached to the plurality of branch pipes 137. As shown in FIGS. 5-8 (and FIG. 1), each sprinkler head 126 may be configured for insertion through the at least one ceiling 112 or the secondary ceiling 117 (again as discussed above depending on how many stories the model structure 210 has). For example, the at least one ceiling 112 (or secondary ceiling 117) may include a plurality of apertures (which may be made by the user or may be already located in the ceiling(s) [112 or 117] provided with the kit 100) and each aperture may be configured to receive a sprinkler head 126 therethrough.

In some embodiments, the plurality of sprinkler heads 126 may include pendant sprinkler heads and/or upright sprinkler heads. For example, as shown in as shown in FIGS. 7-8, when the model structure 210 includes an open concept ceiling 112, upright sprinkler heads may be used. Pendant sprinkler heads may be used for insertion into ceilings 112 or secondary ceilings 117 as discussed above. In some embodiments, the kit 100 may include 12 pendant sprinkler heads and 32 upright sprinkler heads. However, it should be appreciated that the kit 100 is not limited to this number of sprinkler heads 126 (nor is it limited to these types of sprinkler head 126). The plurality of sprinkler heads 126 may be configured to spray water into the at least one room 212 when a predetermined temperature is met. For example, the predetermined temperature may be between 135-165 degrees Fahrenheit.

In some embodiments, the plurality of sprinkler heads 126 may include mechanical means for automatically causing the plurality of sprinkler heads 126 to spray the water once the predetermined temperature is met. For example, each sprinkler head may include a liquid filled bulb configured to burst at the predetermined temperature, causing the water to expel through an open channel in which the bulb previously sat. In other examples, the sprinkler head may include a heat sensitive element configured to melt at the predetermined temperature. Further, in some embodiments, the plurality of sprinkler heads 126 may utilize a heat sensor. The heat sensor may work in combination with the above mentioned mechanisms (or other expanding mechanisms) causing the plurality of sprinkler heads 126 to automatically release the water once the heat sensor senses that the predetermined temperature has been met.

The at least one flow switch 129 may be configured to detect a water flow speed within the model fire sprinkler system 120. Detection of increased water flow speed within the model fire sprinkler system 120 (signaling a leak or the sprinkler heads 126 being activated) may cause the model fire sprinkler system 120 to output an alert such as an audible alarm, a visual indicator, or the like. For example, the model fire sprinkler system 120 may further include a fire alarm (not illustrated) in communication with the at least one flow switch 129 and configured to receive a signal from the at least one flow switch 129 and sound an alarm in response. This may enable the user to establish that they have installed the system correctly and it is working as it should.

It should be appreciated that while a wet fire sprinkler system has been discussed above to provide an exemplary embodiment of the system created by the kit 100, the kit 100 is not limited to a replica of wet fire sprinkler systems. For example, dry fire sprinkler systems may be used in addition to or instead of the wet fire sprinkler system. In this embodiment, the main control assembly 121 may include a compressor (not illustrated) to provide compressed air to the model fire sprinkler system 120 and a dry pipe valve (not illustrated) configured to open when fire is detected, allowing the water through the network of pipes 124 and into the plurality of sprinkler heads 126.

Those with ordinary skill in the art will now appreciate that upon reading this specification and by their understanding the art of fire protection and fire sprinkler systems as described herein, methods of assembly, installation, and the like will be understood by those knowledgeable in such art.

Further, it is contemplated that the kit may provide the user with all elements needed to properly install a fire sprinkler system that replicates a standard fire sprinkler system in fire protection art, even though the elements provided in the kit may be replicas (preferably working replicas) and may include varied sizes to the standard fire sprinkler systems. As such, it should be appreciated that standard elements such as 90° elbows, caps, etc. used in standard fire sprinkler systems are contemplated for inclusion in the kit where necessary. Further, connections made between the elements discussed above, such as the inlet assembly, the network of pipes and the plurality of sprinkler heads are contemplated to include standard fittings and connections used in standard fire sprinkler systems. For example, tee-fittings, groove couplings, riser clamps, wall plates, hangers, beam clamps, and the like. In addition, as discussed above, the model structure 210 may be built as desired by the user in as many configurations and/or with as many stories as desired. As such, the model fire sprinkler system 120 provided with the kit 100 may include universal sizes to fit into the model structure 210 no matter the configuration or number of stories.

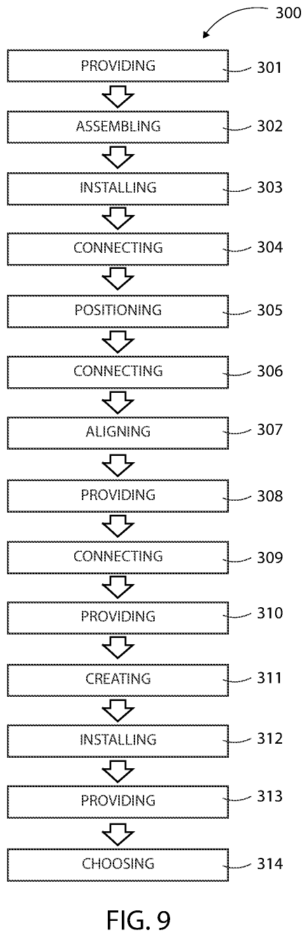

Referring now to FIG. 9 showing a flow diagram illustrating a method 300 method of learning fire sprinkler system installation, according to an embodiment of the present disclosure. In particular, the method 300 may include one or more components or features of the kit 100 as described above. As illustrated, the method 300 may include the steps of: step one 301, providing the kit as above; step two 302, assembling the model structure according to the at least one plan; step three 303, installing the main control assembly within the model structure; step four 304, connecting the network of pipes with the main control assembly; step five 303, positioning each structure connector means from the plurality of structure connector means according to the at least one plan; step six 306, connecting the network of pipes to the model structure via the plurality of structure connector means; and step seven 307, aligning each sprinkler head according to the at least one plan. As above, in some embodiments, each sprinkler head may be inserted through the at least one ceiling/secondary ceiling.

Further steps may include step eight 308, providing the system further comprising a water supply; step nine 309, connecting the inlet assembly to the water supply, thereby causing water from the water supply to be carried through the network of pipes and to the plurality of sprinkler heads, the plurality of sprinkler heads being configured to spray water into the at least one room when a predetermined temperature is met; step ten 310, providing the system wherein the at least one room includes a plurality of rooms; step eleven 311, creating a sprinkler room from the plurality of rooms; step twelve 312, installing the main control assembly within the sprinkler room; step thirteen 313, providing the system wherein the at least one plan includes a plurality of plans and each plan from the plurality of plans includes different information, the information including a visual layout of the model structure and a visual layout of the model fire sprinkler system when installed within the model structure; and step fourteen 314, choosing a plan from the plurality of plans.

It should be noted that certain steps are optional steps and may not be implemented in all cases. Optional steps of method 300 are illustrated using dotted lines in FIG. 9 so as to distinguish them from the other steps of method 300. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for learning and teaching fire sprinkler system installation are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A kit for teaching fire sprinkler system installation, the kit comprising:
a model structure assembly including at least one floor, at least one ceiling and a plurality of walls all configured to be assembled together to form a model structure having at least one story and at least one room;
a model fire sprinkler system for installation into the model structure, the model fire sprinkler system including a main control assembly having an inlet assembly and a plurality of control valves, a network of pipes configured for connection to the inlet assembly, a plurality of structure connector means configured to connect the network of pipes to the model structure, and a plurality of sprinkler heads attached to the network of pipes and configured for installation about the at least one ceiling of the at least one room; and
at least one plan visually outlining information for assembly of the model structure and for installation of the model fire sprinkler system within the model structure.

2. The kit of claim 1, further comprising a water supply;
wherein the inlet assembly is configured for connection to the water supply to receive water therefrom;
wherein the plurality of control valves are configured to control supply of the water through the model fire sprinkler system;
wherein the network of pipes are configured to carry water from the inlet assembly to the plurality of sprinkler heads; and
wherein the plurality of sprinkler heads are configured to spray the water into the at least one room when a predetermined temperature is met.

3. The kit of claim 2, wherein the model fire sprinkler system further includes at least one backflow preventor means configured for connection with the inlet assembly; and
wherein the at least one backflow preventor means is further configured to prevent the water from flowing back into the water supply.

4. The kit of claim 3, wherein the water supply is a water tank.

5. The kit of claim 4, further comprising an electric pump configured to pump water from the water tank and into the inlet assembly.

6. The kit of claim 5, wherein the main control assembly further includes at least one flow switch, and wherein the at least one flow switch is configured to detect a water flow speed within the network of pipes.

7. The kit of claim 6, wherein the main control assembly further includes at least one pressure gauge, and wherein the at least one pressure gauge is configured to indicate a pressure of the water in the model fire sprinkler system.

8. The kit of claim 7, wherein the model fire sprinkler system further includes a test and drain valve, and wherein the test and drain valve allows the user to selectively drain the water from the model fire sprinkler system.

9. The kit of claim 1, wherein the at least one room includes a plurality of rooms, wherein one of the plurality of rooms is a sprinkler room, and wherein the main control assembly is configured for installation in the sprinkler room.

10. The kit of claim 1, wherein the at least one floor includes a floor drain, wherein the at least one floor is angled to direct the water into the floor drain, and wherein the floor drain includes a drainage pipe configured to expel drained water into the water tank.

11. The kit of claim 1, wherein the at least one plan includes a plurality of plans, and wherein each plan from the plurality of plans includes different information.

12. The kit of claim 11, wherein the information includes a visual layout of the model structure, and wherein the information further includes a visual layout of the model fire sprinkler system when installed within the model structure.

13. A method of learning fire sprinkler system installation, the method comprising the steps of:
providing a kit for teaching fire sprinkler system installation, the kit including:
a model structure assembly including at least one floor, at least one ceiling and a plurality of walls all configured to be assembled together to form a model structure having at least one story and at least one room;
a model fire sprinkler system for installation into the model structure, the model fire sprinkler system including a main control assembly having an inlet assembly and a plurality of control valves, a network of pipes configured for connection to the inlet assembly, a plurality of structure connector means configured to connect the network of pipes to the model structure, and a plurality of sprinkler heads attached to the network of pipes and configured for installation about the at least one ceiling of the at least one room; and
at least one plan visually outlining information for assembly of the model structure and for installation of the model fire sprinkler system within the model structure;
assembling the model structure according to the at least one plan;
installing the main control assembly within the model structure;
connecting the network of pipes with the main control assembly;
positioning each structure connector means from the plurality of structure connector means according to the at least one plan;
connecting the network of pipes to the model structure via the plurality of structure connector means; and
aligning each sprinkler head according to the at least one plan.

14. The method of claim 13, further comprising the steps of:
providing the system further comprising a water supply; and
connecting the inlet assembly to the water supply, thereby causing water from the water supply to be carried through the network of pipes and to the plurality of sprinkler heads, the plurality of sprinkler heads being configured to spray water into the at least one room when a predetermined temperature is met.

15. The method of claim 14, wherein the water supply is a water tank and wherein the system further comprises an electric pump configured to pump water from the water tank and into the inlet assembly.

16. The method of claim 15, wherein the at least one floor includes a floor drain, wherein the at least one floor is angled to direct the water into the floor drain, and wherein the floor drain includes a drainage pipe configured to expel drained water.

17. The method of claim 13, further comprising the steps of:
providing the system wherein the at least one room includes a plurality of rooms;
creating a sprinkler room from the plurality of rooms; and
installing the main control assembly within the sprinkler room.

18. The method of claim 13, further comprising the steps of:
providing the system wherein the at least one plan includes a plurality of plans and each plan from the plurality of plans includes different information, the information including a visual layout of the model structure and a visual layout of the model fire sprinkler system when installed within the model structure; and
choosing a plan from the plurality of plans.

19. The method of claim 16, wherein the model fire sprinkler system further includes at least one backflow preventor means, at least one flow switch, at least one pressure gauge, and a test and drain valve;
wherein at least one backflow preventor means is configured for connection with the inlet assembly and to prevent the water from flowing back into the water supply;
wherein the at least one flow switch is configured to detect a water flow speed within the network of pipes; and
wherein the at least one pressure gauge is configured to indicate a pressure of the water.

20. A kit for teaching fire sprinkler system installation, the kit comprising:
a model structure assembly including at least one floor, at least one ceiling and a plurality of walls all configured to be assembled together to form a model structure having at least one story and a plurality of rooms, the plurality of rooms including a sprinkler room, the at least one floor including a floor drain, the floor drain being angled to direct the water into the floor drain and including a drainage pipe configured to expel drained water;
a model fire sprinkler system for installation into the model structure, the model fire sprinkler system including a water tank, an electric pump configured to pump water from the water tank, a main control assembly having an inlet assembly configured for connection to the water tank to receive water therefrom, a plurality of control valves configured to control supply of the water through the model fire sprinkler system, at least one backflow preventor means configured for connection with the inlet assembly and to prevent the water from flowing back into the water tank, and at least one pressure gauge configured to indicate a pressure of the water in the model fire sprinkler system, a network of pipes configured for connection to the main control assembly and to carry water from the inlet assembly to a plurality of sprinkler heads, at least one flow switch configured to detect a water flow speed within the network of pipes, a plurality of structure connector means configured to connect the network of pipes to the model structure, the plurality of sprinkler heads attached to the network of pipes and configured for installation about the ceiling of the at least one room, the plurality of sprinkler heads further configured to spray water into the at least one room when a predetermined temperature is met; and
a plurality of plans each visually outlining information for assembly of the model structure and for installation of the model fire sprinkler system within the model structure, each plan including different information, the information includes a visual layout of the model structure and a visual layout of the model fire sprinkler system when installed within the model structure.
